(19) United States
(12) Patent Application Publication
(10) Pub. No.: US 2022/0277038 A1
(43) Pub. Date: Sep. 1, 2022

(54) IMAGE SEARCH BASED ON COMBINED LOCAL AND GLOBAL INFORMATION

(71) Applicant: GUANGDONG OPPO MOBILE TELECOMMUNICATIONS CORP., LTD., Dongguan (CN)

(72) Inventors: Yikang LI, Palo Alto, CA (US); Jenhao HSIAO, Palo Alto, CA (US)

(21) Appl. No.: 17/749,983

(22) Filed: May 20, 2022

Related U.S. Application Data
(63) Continuation of application No. PCT/CN2020/128459, filed on Nov. 12, 2020.
(60) Provisional application No. 62/939,135, filed on Nov. 22, 2019.

(51) Int. Cl. G06F 16/583; G06F 16/532; G06F 16/54; G06V 10/774; G06N 3/04

(52) U.S. Cl. CPC G06F 16/583; G06F 16/532; G06F 16/54; G06V 10/774; G06N 3/04

(57) ABSTRACT

Methods, devices related to image retrieval are described herein. A method for performing an image search includes receiving a textual search term from a user, determining a first semantic representation of the textual search term, and determining differences between the first semantic representation and multiple semantic representations that correspond to a plurality of images. Each of the multiple semantic representations is determined based on combining local and global information of a corresponding image. The local information indicates a correlation between features of the corresponding image, and the global information indicates a correspondence between the features of the corresponding image and one or more semantic categories. The method also includes retrieving one or more images as search results in response to the textual search term based on the determined differences.

### CROSS-REFERENCE TO RELATED APPLICATIONS

This application is a continuation of International Application No. PCT/CN2020/128459, filed Nov. 12, 2020, which claims priority to U.S. Application No. 62/939,135, filed Nov. 22, 2019, the entire disclosures of which are incorporated herein by reference.

### TECHNICAL FIELD

This document generally relates to image search, and more particularly to text-to-image searches using neural networks.

### BACKGROUND

An image retrieval system is a computer system for searching and retrieving images from a large database of digital images. The rapid increase of the number of photos taken by smart devices has incentivize further development in text-to-photo retrieval techniques to efficiently find a desired image from a massive amount of photo.

### SUMMARY

Disclosed are devices and methods for performing text-to-image searches. The disclosed techniques can be applied in various embodiments, such as mobile devices or cloud-based photo album services.

In one example aspect, a method for training an image search system is disclosed. The method includes obtaining classified features of the image using a neural network; determining, based on the classified features, local information that indicates a correlation between the classified features; and determining, based on the classified features, global information that indicates a correspondence between the classified features and one or more semantic categories. The method also includes deriving, based on a target semantic representation associated with the image, a semantic representation of the image by combining the local information and the global information.

In another example aspect, a method for performing an image searching is disclosed. The method includes receiving a textual search term from a user, determining a first semantic representation of the textual search term, and determining differences between the first semantic representation and multiple semantic representations that correspond to multiple of images. Each of the multiple semantic representations is determined based on combining local and global information of a corresponding image. The local information indicates a correlation between features of the corresponding image, and the global information indicates a correspondence between the features of the corresponding image and one or more semantic categories. The method also includes retrieving one or more images as search results in response to the textual search term based on the determined differences.

In another example aspect, a mobile device includes a processor, a memory including processor executable code, and a display. The processor executable code upon execution by the processor configures the processor to implement the described methods. The display is coupled to the processor configured to display search results to the user.

These and other features of the disclosed technology are described in the present document.

### BRIEF DESCRIPTION OF THE DRAWINGS

FIG. 1 illustrates an example architecture of a text-to-image search system in accordance with the present disclosure.

FIG. 2A shows an example set of search results given a query term.

FIG. 2B shows another example set of search results given a different query term.

FIG. 3 shows yet another example set of search results given a query term.

FIG. 4 is a flowchart representation of a method for training an image search system in accordance with the present disclosure.

FIG. 5 is a flowchart representation of a method for performing image search in accordance with the present disclosure.

FIG. 6 is a block diagram illustrating an example of the architecture for a computer system or other control device that can be utilized to implement various portions of the presently disclosed technology.

FIG. 7 is a block diagram illustrating an example of the architecture for a terminal device.

### DETAILED DESCRIPTION

Smartphones nowadays can capture a large number of photos. The sheer amount of image data poses a challenge to photo album designs as a user may have gigabytes of photos stored on his or her phone and even more on a cloud-based photo album service. It is thus desirable to provide a search function that allows retrieval of the photos based on simple keywords (that is, text-to-image search) instead of forcing the user to scroll back and forth to find a photo showing a particular object or a person. However, unlike existing images on the Internet that provide rich metadata, user-generated photos typically include little or no meta information, making it more difficult to identify and/or categorize objects or people in the photos.

Currently, there are two common approaches to perform text-to-image searches. The first approach is based on learning using deep convolutional neural networks. The output layer of the neural network can have as many units as the number of classes of features in the image. However, as the number of classes grows, the distinction between classes blurs. It thus becomes difficult to obtain sufficient numbers of training images for uncommon target objects, which impacts the accuracy of the search results.

The second approach is based on image classification. The performance of image classification has recently witnessed a rapid progress due to the establishment of large-scale hand-labeled datasets. Many efforts have been dedicated to extending deep convolutional networks for single/multi-label image recognition. For image search applications, the search engine directly uses the labels (or the categories), predicted by trained classifier, as the indexed keywords for each photo. During a search stage, exact keyword matching is performed to retrieve photos having the same label as the user's query. However, this type of search is limited to predefined keywords. For example, users can get related photos using the query term “car” (which is one of the default categories in the photo album system) but may fail to obtain any results using the query term “vehicle” despite that “vehicle” is a synonym of “car.”

Techniques disclosed in this document can be implemented in various image search systems to allow the users to search through photos based on semantic correspondence between the textual keywords and the photos without requiring an exact match of the labels or categories. In such manner, the efficiency and accuracy of the image searches is improved. For example, users can use a variety of search terms, including synonyms or even brand names, to obtain desired search results. The search systems can also achieve more accuracy by leveraging both local and global information presented in the image datasets.

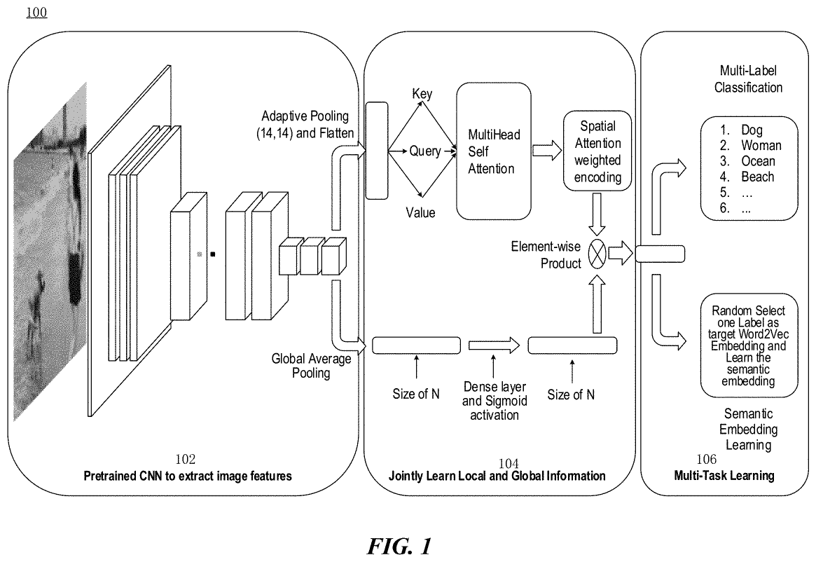

FIG. 1 illustrates an example architecture of a text-to-image search system 100 in accordance with the present disclosure. The search system 100 can be trained to map images and search terms into new representations (e.g., vectors) in a visual-semantic embedding space. Given a textual search term, the search system 100 compares the distance between the representations denoting the similarity between these two modalities to obtain image results.

In some embodiments, the search system 100 includes a feature extractor 102 that can extract image features from the input images. The search system 100 also includes an information combiner 104 that combines global and local information in the extracted features and a multi-task learning module 106 to perform multi-label classification and semantic embedding at the same time.

In some embodiments, the feature extractor 102 can be implemented using a Convolutional Neural Network (CNN) that performs image classification given an input dataset. For example, Squeeze-and-Excitation ResNet 152 (SE-ResNet152), a Convolutional Neural Network (CNN) in image classification task on ImageNet dataset, can be leveraged as the feature extractor of the search system. The feature maps from the last convolutional layer of the CNN are provided as the input for the information combiner 104.

In some embodiments, inputs to the information combiner 104 are split into two streams: one stream for local/spatial information and the other stream for global information.

The local information provides correlation of spatial features within one image. Human visual attention allows us to focus on a certain region of an image while perceiving the surrounding image as a background. Similarly, more attention is given to certain groups of words (e.g., verbs and corresponding nouns) while less attention is given to the rest of the words in the sentence (e.g., adverbs and/or propositions). Attention in deep learning thus can be understood as a vector of importance weights. For example, a Multi-Head Self-Attention (MHSA) module can be used for local information learning. The MHSA module implements a multi-head self-attention operation, which assigns weights to indicate how much attention the current feature pays to the other features and obtains the representation that includes context information by a weighted summation. It is noted that while the MHSA module is provided herein as an example, other attention-based learning mechanisms, such as content-based attention or self-attention, can be adopted for local/spatial learning as well.

In the MHSA module, each point of the feature map can be projected into several Key, Query, and Value sub-spaces (which is referred to as “Multi-Head”). The module can learn the correlation by leveraging the dot product of Key and Query vectors. The output correlation scores from the dot product of Key and Query are then activated by an activation function (e.g., Softmax or Sigmoid function). The weighted encoding feature maps are obtained by multiplying the correlation scores with the Value vectors. The feature maps are then concatenated together from all the sub-spaces and then projecting back to the original space as the input of a spatial attention layer. The mathematical equations of MHSA can be defined as follows:

$$SelfAttention ( Q , K , V ) = σ ( \frac{{QK}^{T}}{\sqrt{{d}_{k}}} ) V \qquad Eq . ( 1 )$$

$$MHSA ( Q , K , V ) = Concat ( {heads}_{1} , … , {heads}_{n} ) {W}^{O} \qquad Eq . ( 2 )$$

Here, a is the activation function (e.g., Softmax or Sigmoid function) and W° is the weight of back-projection from multi-head sub-space to the original space. Eq. (1) is the definition of attention and Eq. (2) defines the Multi-Head Self-Attention operation.

The spatial attention layer can enhance the correlation of feature patterns and the corresponding labels. For example, the weighted feature maps from the MHSA layer can be mapped to a score vector using the spatial attention layer. The weighted vectors (e.g., context vectors) thus include both intra-relationship between different objects and inter-relationship between objects and labels. The spatial attention layer can be described as follows:

SPAttention=σ(MHSA×W^{SP}) Eq. (3)

Context=(SPAttension·MHSA) Eq. (4)

Here, a is the activation function (e.g., Softmax or Sigmoid function) and W^{SP} is the weight of spatial attention layer. The context vector in Eq. (4) can also be called weighted encoding attention vector.

For global information stream, a global pooling layer can be used to process the outputs of the classification neural network (e.g., the last convolutional layer of the CNN). One advantage of global pooling layer is that it can enforce correspondences between feature maps and categories. Thus, the feature maps can be easily interpreted as categories confidence maps. Another advantage is that overfitting can be avoided at this layer. After the pooling operation, a dense layer with a Sigmoid function can be applied to obtain a global information vector. Each element of the vector can thus be viewed as a probability. The global information vector can be defined as:

Global=σ(GP×W^{GP}) Eq. (5)

Here, the σ is the Sigmoid function, GP is the output of global pooling and the W^{GP} is the weight of dense layer.

The global information and the local attention are then combined jointly to improve the accuracy of the learning and subsequent searches. In some embodiments, an element-wise product (e.g., Hadamard Product) can be used to combine the global and local information. The encoded information vector can be represented as:

Encoded=Global⊙Context Eq. (6)

Here, ⊙ is the Hadamard product. The element-wise product is selected because both global information and spatial attention are from the same feature map. Therefore, the local information (e.g., spatial attention score vector) can be treated as a guide to weigh the global information (e.g., the global weighted vector). For instance, when an image includes labels or categories like “scenery”, “grassland” and “mountain,” the probability of having related elements (e.g., “sheep” and/or “cattle”) in the same image may also be high. However, the spatial attention vector can emphasize “grassland” and “mountain” areas so that the global information provides a higher probability for elements that are a combination of “grassland” and “mountain” while decreasing the probability for “sheep” or “cattle” as no relevant objects are shown in the image.

The combined information vector obtained from abovementioned steps is then fed to the multi-task learning module 106 as the input of both classification layer and semantic embedding layer. The classification layer can output a vector that has the same dimension as the number of categories of the input dataset, which can also be activated by a Sigmoid function. In some embodiments, a weighted Binary Cross-Entropy (BCE) loss function is implemented for the multi-label classification, which can be presented as follows:

Loss_{c}=a·(Y log(\tilde{Y})+b·((1−Y)log(1−\tilde{Y})) Eq. (7)

Here, a and b are the weights for positive and negative samples respectively. The Y and \tilde{Y} are the ground truth labels and the predicted labels respectively.

In some embodiments, for semantic embedding, an image can be randomly selected as the target embedding vector to learn the image-sentence pairs. In some embodiments, a Cosine Similarity Embedding Loss function is used for learning the semantic embedding vectors. For example, the target ground truth embedding vectors, i.e., the target vector, can be obtained from a pretrained Word2Vec model. The Cosine Similarity Embedding Loss function can be described as:

$${Loss}_{c} = \{ \begin{matrix}1 - cos ( Z , \tilde{Z} ) , if Y = 1 \\ max ( 0 , cost ( Z , \tilde{Z} ) - margin ) , if Y = - 1\end{matrix} \qquad Eq . ( 8 )$$

Here, Z and \tilde{Z} are the target word embedding vectors and generated semantic embedding vectors and the margin is the value of controlling the dissimilarity which can be set from [−1, 1]. The Cosine Similarity Embedding Loss function tries to force the embedding vectors to approach the target vector if they are from the same category and to push them further from each other if they are from different categories.

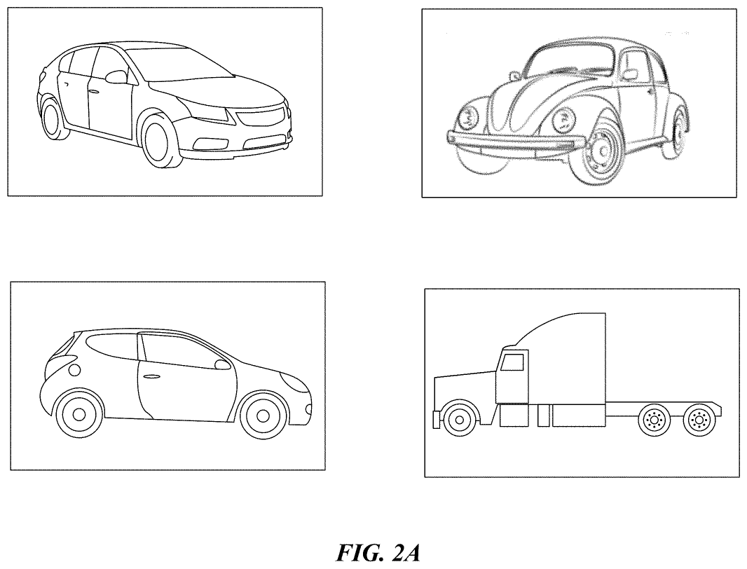

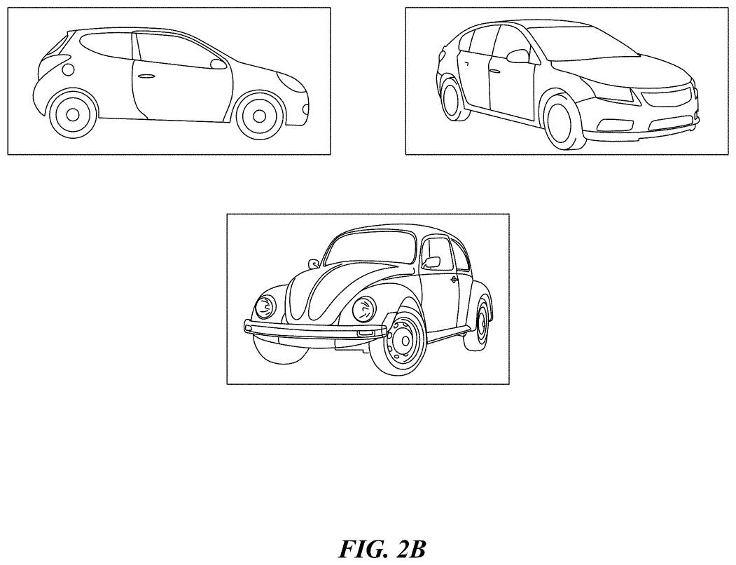

At offline training stage, all photos in a user's photo album can be indexed via the visual-semantic embedding techniques as described above. For example, when the user captures a new photo, the system first extracts features of the image and then transforms the features to one or more vectors corresponding to the semantic meanings. At search time, when the user provides a text query, the system computes the corresponding vector of the text query and searches for the images having closest corresponding semantic vectors. Top-ranked photos are then returned as the search results. Thus, given a set of photos in a photo album and a query term, the search system can locate related images in the photo album that have semantic correspondence with the given text term, even when the term does not belong to any pre-defined categories. FIG. 2A shows an example set of search results given a query term “car.” FIG. 2B shows another example set of search results given a query term “Mercedes-Benz,” which does not belong to any pre-defined categories. As shown in FIG. 2B, the system is capable of retrieving related photos based on the semantic meaning of the query term, even though there are no “Mercedes-Benz” photos in the photo album.

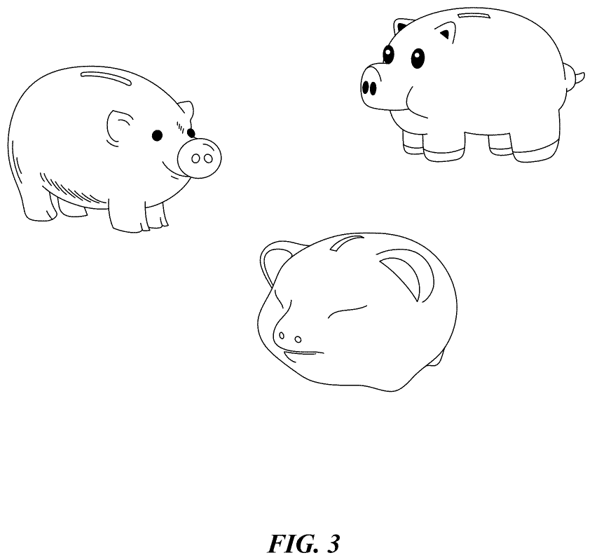

Furthermore, using the disclosed techniques, it is possible to obtain fuzzy search results based on semantically related concepts. For example, piggy banks are not directly related to the term “deposit” but offer a similar semantic meaning. As shown in FIG. 3, when provided with “deposit” as the query term, the image search system can retrieve piggy bank images as the top-related photos.

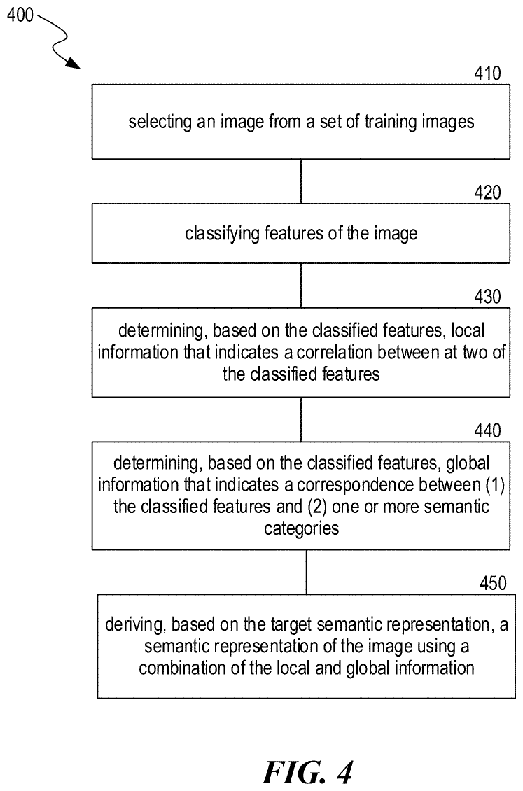

FIG. 4 is a flowchart representation of a method 400 for training an image search system in accordance with the present technology. The method 400 includes, at operation 410, selecting an image from a set of training images. The image is associated with a target semantic representation. In some embodiments, the target semantic is obtained by using a word2vec model. The method 400 includes, at operation 420, classifying features of the image using a neural network. For example, the classified features of the image are obtained by using a feature extraction module, such as the SE-ResNet152. The method 400 includes, at operation 430, determining, based on the classified features, local information that indicates a correlation between the classified features. The method 400 includes, at operation 440, determining, based on the classified features, global information that indicates a correspondence between the classified features and one or more semantic categories. The method 400 also includes, at operation 450, deriving, based on the target semantic representation, a semantic representation of the image by combining the local and global information.

In some embodiments, the method includes splitting the classified features to a number of streams. For example, the classified features are input to two streams of the information combiner module. The local information is determined based on a first stream, i.e., the stream for local/spatial information, and the global information is determined based on a second stream, i.e., the stream for global information. In some embodiments, the local information is determined based on a multi-head self-attention operation. For example, the local information may be determined by performing the multi-head self-attention operation on the classified features. In some embodiments, the local information is represented as one or more weighted vectors indicating the correlation between the classified features. In some embodiments, the global information is determined based on a global pooling operation. For example, the global information may be determined by performing the global pooling operation on the classified features. In some embodiments, the global information is represented as one or more weighted vectors based on results of the global pooling operation. In some embodiments, the local information and the global information are represented as vectors, and the local information and the global information are combined by performing an element-wise product of the vectors. In some embodiments, the element-wise product refers to a Hadamard product.

In some embodiments, deriving the semantic representation of the image includes determining one or more semantic labels that correspond to the one or more semantic categories based on a first loss function. In some embodiments, the first loss function includes a weighted cross entropy loss function. In some embodiments, the semantic representation of the image is derived based on a second loss function that reduces a difference between the semantic representation and the target semantic representation. In some embodiments, the second loss function includes a Cosine similarity function. In some embodiments, a multi-label classification and a semantic embedding are simultaneously performed by using a multi-task learning module.

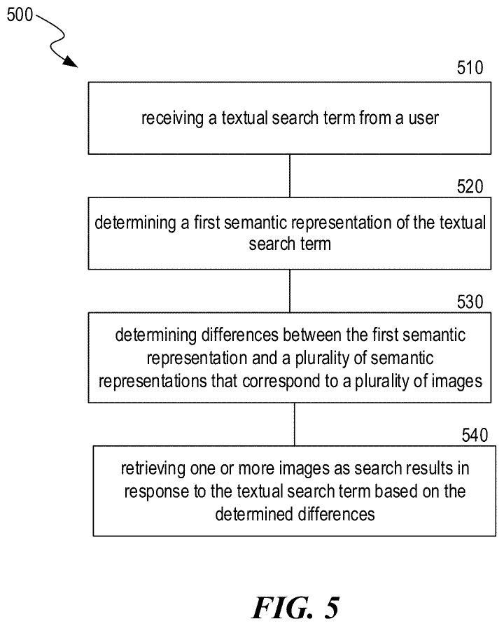

FIG. 5 is a flowchart representation of a method 500 for performing image search in accordance with the present disclosure. The method 500 includes, at operation 510, receiving a textual search term from a user. The method 500 includes, at operation 520, determining a first semantic representation of the textual search term. The method 500 includes, at operation 530, determining differences between the first semantic representation and multiple semantic representations that correspond to multiple images. Each of the multiple semantic representations is determined based on combining local and global information of a corresponding image. The local information indicates a correlation between features of the corresponding image, and the global information indicates a correspondence between the features of the corresponding image and one or more semantic categories. The method 500 also includes, at operation 540, retrieving one or more images as search results in response to the textual search term based on the determined differences.

In some embodiments, the local information of the corresponding image is determined based on classifying the features of the corresponding image using a neural network and performing a multi-head self-attention operation on the features. In some embodiments, the local information is represented as one or more weighted vectors indicating the correlation between the features. In some embodiments, the global information of the corresponding image is determined based on classifying the features of the corresponding image using a neural network and performing a global pooling operation on the features. In some embodiments, the global information is represented as one or more weighted vectors based on results of the global pooling operation. In some embodiments, the local information and the global information are represented as vectors, and the local information and the global information are combined as an element-wise product of the vectors. In some embodiments, the element-wise product refers to a Hadamard product. In some embodiments, determining the differences between the first semantic representation and the multiple semantic representations includes calculating a Cosine similarity between the first semantic representation and each of the multiple of semantic representations. The calculated cosine similarity is taken as the difference. In some embodiments, one or more images with high semantic similarities are selected as the search results in response to the textual search term, and the one or more images are displayed to the user.

In some embodiments, a non-transitory computer-program storage medium is provided. The computer-program storage medium includes code stored thereon. The code, when executed by a processor, causes the processor to implement the described method.

In some embodiments, an image retrieval system includes one or more processors, and a memory including processor executable code. The processor executable code upon execution by at least one of the one or more processors configures the at least one processor to implement the described methods.

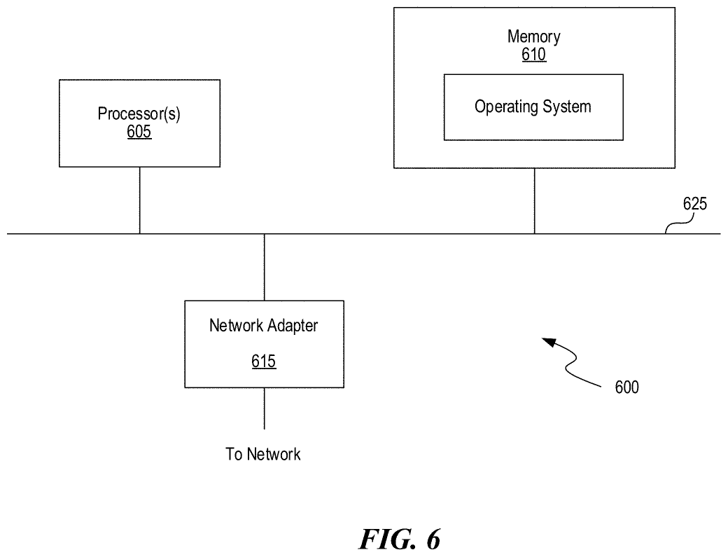

FIG. 6 is a block diagram illustrating an example of the architecture for a computer system or other control device 600 that can be utilized to implement various portions of disclosed techniques, such as the image search system. In FIG. 6, the computer system 600 includes one or more processors 605 and memory 610 connected via an interconnect 625. The interconnect 625 may represent any one or more separate physical buses, point to point connections, or both, connected by appropriate bridges, adapters, or controllers. The interconnect 625, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 605 may include central processing units (CPUs) to control the overall operation of, for example, the host computer. The processor(s) 605 can also include one or more graphics processing units (GPUs). In certain embodiments, the processor(s) 605 accomplish this by executing software or firmware stored in memory 610. The processor(s) 605 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 610 can be or include the main memory of the computer system. The memory 610 represents any suitable form of random access memory (RAM), read-only memory (ROM), flash memory, or the like, or a combination of such devices. In use, the memory 610 may contain, among other things, a set of machine instructions which, upon execution by processor 605, causes the processor 605 to perform operations to implement embodiments of the presently disclosed technology.

Also connected to the processor(s) 605 through the interconnect 625 is a (optional) network adapter 615. The network adapter 615 provides the computer system 600 with the ability to communicate with remote devices, such as the storage clients, and/or other storage servers, and may be, for example, an Ethernet adapter or Fiber Channel adapter.

The disclosed techniques can allow an image search system to better capture multi-objects spatial relationship in an image. The combination of the local and global information in the input image can enhance the accuracy of the derived spatial correlation among features and between features and the corresponding semantic categories. As compared to existing techniques that directly use the summation of vectors of all labels (e.g., categories), where the summed vector can potentially lose the original meaning in the semantic space, the disclosed techniques avoid changing the semantic meaning of each label. The learned semantic embedding vectors thereby include both the visual information of images and the semantic meaning of labels.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

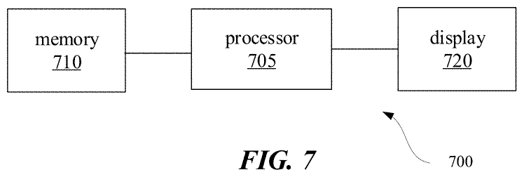

In some embodiments, a mobile device is provided. As illustrated in FIG. 7, the mobile device 700 includes a processor 705, a memory 710, and a display 720. The processor 705 includes processor executable code, and the processor executable code upon execution by the processor 705 configures the processor 705 to implement the described methods. The display 720 is coupled to the processor 705 and is configured to display search results to the user.

In some embodiments, the method includes the operations as follows. A textual search term from a user is received. A first semantic representation of the textual search term is determined. Differences between the first semantic representation and multiple semantic representations that correspond to the images are determined. Based on the determined differences, one or more images are retrieved as search results in response to the textual search term. Each of the number of semantic representations is determined based on combining local information and global information of a corresponding image, the global information indicates a correspondence between features of the corresponding image and one or more semantic categories, and the local information indicates a correlation between at least two of the features of the corresponding image.

It is intended that the specification, together with the drawings, be considered exemplary only, where exemplary means an example.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method for training an image search system, comprising:
selecting an image from a set of training images, wherein the image is associated with a target semantic representation;
obtaining, using a neural network, classified features of the image;
determining, based on the classified features, local information, wherein the local information indicates a correlation for at least two of the classified features;
determining, based on the classified features, global information, wherein the global information indicates a correspondence between the classified features and one or more semantic categories; and
deriving, based on the target semantic representation associated with the image, a semantic representation of the image using a combination of the local information and the global information.

2. The method of claim 1, further comprising:
after the classified features are obtained, inputting the classified features to a plurality of streams, wherein the local information is determined based on a first stream and the global information is determined based on a second stream.

3. The method of claim 1, wherein the determining, based on the classified features, local information, comprises:
determining the local information by performing a multi-head self-attention operation on the classified features.

4. The method of claim 3, wherein the local information is represented as one or more weighted vectors indicating the correlation between the classified features.

5. The method of claim 1, wherein the determining, based on the classified features, global information, comprises:
determining the global information by performing a global pooling operation on the classified features.

6. The method of claim 5, wherein the global information is represented as one or more weighted vectors based on results of the global pooling operation.

7. The method of claim 1, wherein the local information and the global information are represented as vectors, and before the semantic representation of the image is derived, the method further comprises:
performing an element-wise product of the vectors to obtain the combination of the local information and the global information.

8. The method of claim 1, wherein deriving the semantic representation of the image comprises:
determining, based on a first loss function, one or more semantic labels that correspond to the one or more semantic categories, wherein the first loss function comprises a weighted cross entropy loss function, and
deriving, based on a second loss function, the semantic representation of the image, wherein the second loss function reduces a difference between the semantic representation of the image and the target semantic representation associated with the image.

9. The method of claim 8, wherein the second loss function comprises a cosine similarity function.

10. The method of claim 1, wherein deriving the semantic representation of the image comprises:
performing, using a multi-task learning module, a multi-label classification and a semantic embedding simultaneously based on the combination of the local information and the global information.

11. The method of claim 1, further comprising:
obtaining, using a word2vec model, the target semantic representation associated with the image.

12. A method for performing an image searching, comprising:
receiving a textual search term from a user;
determining a first semantic representation of the textual search term;
determining differences between the first semantic representation and a plurality of semantic representations that correspond to a plurality of images, wherein each of the plurality of semantic representations is determined based on combining local information and global information of a corresponding image, the global information indicates a correspondence between features of the corresponding image and one or more semantic categories, and the local information indicates a correlation between at least two of the features of the corresponding image; and
retrieving, based on the determined differences, one or more images as search results in response to the textual search term.

13. The method of claim 12, wherein the local information of the corresponding image is determined based on:
classifying the features of the corresponding image using a neural network; and
performing a multi-head self-attention operation on the features.

14. The method of claim 13, wherein the local information is represented as one or more weighted vectors indicating the correlation between the features.

15. The method of claim 12, wherein the global information of the corresponding image is determined based on:
obtaining the features of the corresponding image using a neural network; and
performing a global pooling operation on the features.

16. The method of claim 15, wherein the global information is represented as one or more weighted vectors based on results of the global pooling operation.

17. The method of claim 12, wherein the local information and the global information are represented as vectors, and the local information and the global information are combined as an element-wise product of the vectors.

18. The method of claim 12, wherein determining the differences between the first semantic representation and the plurality of semantic representations comprises:
calculating, as the difference, a cosine similarity between the first semantic representation and each of the plurality of semantic representations.

19. The method of claim 12, wherein after the retrieving, based on the determined differences, one or more images as search results in response to the textual search term, the method further comprises:
displaying the one or more images to the user.

20. A mobile device, comprising:
a processor,
a memory including executable code, wherein upon execution of the executable code by the processor, the processor is configured to:
receive a textual search term from a user;
determine a first semantic representation of the textual search term;
determine differences between the first semantic representation and a plurality of semantic representations that correspond to a plurality of images, wherein each of the plurality of semantic representations is determined based on combining local information and global information of a corresponding image, the global information indicates a correspondence between features of the corresponding image and one or more semantic categories, and the local information indicates a correlation between at least two of the features of the corresponding image; and
retrieve, based on the determined differences, one or more images as search results in response to the textual search term, and
a display coupled to the processor, wherein the display is configured to display the one or more images.
